(19) United States
(12) Patent Application Publication
(10) Pub. No.: US 2026/0163253 A1
(43) Pub. Date: Jun. 11, 2026

(54) ANTENNA AND ELECTRONIC DEVICE

(71) Applicant: Huawei Technologies Co., Ltd., Shenzhen (CN)

(72) Inventors: Meng Xue, Xi'an (CN); Zhengyuan Hu, Xi'an (CN); Chengcheng Nie, Xi'an (CN); Qian Zhang, Xi'an (CN)

(21) Appl. No.: 19/425,345

(22) Filed: Dec. 18, 2025

Related U.S. Application Data
(63) Continuation of application No. PCT/CN2024/096100, filed on May 29, 2024.

(30) Foreign Application Priority Data
Aug. 24, 2023 (CN) 202311076486.2

(51) Int. Cl. H01Q 21/28; H01Q 5/35; H01Q 9/04; H01Q 15/00

(52) U.S. Cl. CPC H01Q 21/28; H01Q 5/35; H01Q 9/0407; H01Q 15/0086

(57) ABSTRACT

In accordance with an embodiment an antenna that includes a conductive plate and at least three antenna structures. The conductive plate includes two plate parts disposed at a first included angle that is less than 180°. Each antenna structure is located on a side of the conductive plate away from the first included angle. Each antenna structure includes a first radiation part and a second radiation part, each radiation part is electrically connected to a plate part, and there is a gap between the two radiation parts. Two of the at least three antenna structures are arranged in a first direction, and two of the at least three antenna structures are arranged in a second direction. The first direction and the second direction are set at a specified included angle. The second radiation parts of the at least three antenna structures are located on a same side of a second plate part.

### CROSS-REFERENCE TO RELATED APPLICATIONS

This application is a continuation of International Application No. PCT/CN 2024/096100, filed on May 29, 2024, which claims priority to Chinese Patent Application No. 202311076486.2, filed on Aug. 24, 2023. The disclosures of the aforementioned applications are hereby incorporated by reference in their entireties.

### TECHNICAL FIELD

This application relates to the field of communication technologies, and in particular, to an antenna and an electronic device.

### BACKGROUND

With development of economy and continuous progress of communication technologies, position-based services are increasingly vital for enhancing convenience of people's daily life.

An ultra-wideband (UWB) positioning technology has advantages such as high positioning accuracy, a strong anti-interference capability, a high operating frequency, a small size, and low power consumption. Therefore, in recent years, UWB antennas have been increasingly used in electronic devices to implement positioning functions of the electronic devices. Currently, consumer electronic devices usually have design requirements for miniaturization, lightness, and thinness, and integrate an increasing quantity of functions. This results in limited space reserved for an UWB antenna on the electronic device, and therefore, the electronic device has a gradually strong requirement for miniaturization of the UWB antenna accordingly. In view of this, how to implement a miniaturized design of the UWB antenna has become a problem urgently to be resolved by a person skilled in the art.

### SUMMARY

This application provides an antenna and an electronic device, to implement a miniaturized design of the antenna, thereby improving flexibility of disposing the antenna in the electronic device.

According to a first aspect, this application provides an antenna. The antenna includes a conductive plate and at least three antenna structures. The conductive plate includes a first plate part and a second plate part. An edge of the first plate part is connected to an edge of the second plate part. There is a first included angle between the first plate part and the second plate part, and first included angle is less than 180°. Each antenna structure includes a first radiation part and a second radiation part. The first radiation part and the second radiation part are both located on a side that is of the conductive plate and that is away from the first included angle, so that the antenna structure can implement directional radiation of a signal in a direction away from the first included angle. The first radiation part includes a first side edge and a third side edge that are disposed opposite to each other. The first side edge is electrically connected to the first plate part, and the third side edge is closer to the second radiation part than the first side edge. The second radiation part includes a second side edge and a fourth side edge that are disposed opposite to each other. The second side edge is electrically connected to the second plate part, and the fourth side edge is closer to the first radiation part than the second side edge. In addition, the third side edge and the fourth side edge are spaced away from each other, to form a slot between the third side edge and the fourth side edge. In this way, the antenna structure can radiate a signal through the slot. The at least three antenna structures include a first antenna structure, a second antenna structure, and a third antenna structure. When the first antenna structure, the second antenna structure, and the third antenna structure are arranged, the first antenna structure and the second antenna structure may be arranged in a first direction, the first antenna structure and the third antenna structure are arranged in a second direction, and the first direction and the second direction are set at a specified included angle. In addition, second radiation parts of the antenna structures are disposed on a same side of the second plate part and are disposed on a same plane. According to the antenna provided in this application, the first plate part and the second plate part of the conductive plate are disposed at the first included angle less than 180°, the first radiation part and the second radiation part are respectively connected to the first plate part and the second plate part electrically, and a radiation gap is reserved between the first radiation part and the second radiation part. In this way, while directional radiation of a signal by the antenna structure is implemented, a projection area of the antenna structure on a plane on which the first radiation part is located and a projection area of the antenna structure on a plane on which the second radiation part is located are both small. This helps reduce a size of the entire antenna. When the antenna is used in the electronic device, the antenna can meet a requirement of being disposed on a side surface of the electronic device, to improve flexibility of disposing the antenna in the electronic device. This helps improve use convenience of the electronic device. In addition, in the antenna, two of the at least three antenna structures are arranged in the first direction, and two of the at least three antenna structures are arranged in the second direction. In this way, the two antenna structures can perform angle measurement and ranging in the first direction, and the two antenna structures can perform angle measurement and ranging in the second direction, to accurately position a to-be-measured object.

In this application, first included angle is not specifically limited. For example, the first plate part and the second plate part may be disposed perpendicularly, and the angle of the first included angle may be 90°. This helps further reduce a size of the antenna.

Because the third side edge of the first radiation part is closer to the second radiation part than the first side edge, and the fourth side edge of the second radiation part is closer to the first radiation part than the second side edge, the plane on which the first radiation part is located and the plane on which the second radiation part is located are intersected. In a possible implementation of this application, the plane on which the first radiation part is located and the plane on which the second radiation part is located are perpendicular to each other. This helps improve symmetry of the antenna structure, thereby improving symmetry of a pattern of the antenna structure.

In a possible implementation of this application, second radiation parts of the antenna structures may be disposed on a same plane, to help implement directional radiation of a signal by the antenna.

In addition, the third side edge of the first radiation part of each antenna structure is located on the plane on which the second radiation part is located, to implement directional radiation of a signal by the antenna in a direction in which the second radiation part is away from the second plate part.

Because a frequency offset of the antenna structure may be adjusted by adjusting a spacing between the third side edge and the fourth side edge, in a possible implementation of this application, a spacing d1 between the third side edge and the fourth side edge satisfies: 0.02λ≤d1≤0.04λ, where λ is a dielectric wavelength corresponding to a center frequency of an operating frequency band of the antenna.

In addition, a width d2 of the first radiation part from the first side edge to the third side edge and a width d3 of the second radiation part from the second side edge to the fourth side edge satisfy: d2/d3=0.8 to 1.2. This helps improve symmetry of the antenna structure, thereby improving symmetry of a pattern of the antenna structure.

In a possible implementation of this application, a length of the third side edge is less than or equal to d1+d2+d3, and a length of the fourth side edge is less than or equal to d1+d2+d3, where λ0/4≤d1+d2+d3<λ0/2, and λ0 is a wavelength corresponding to the center frequency of the operating frequency band of the antenna in free space. This can ensure that the antenna can operate in a required frequency band.

In this application, to implement an electrical connection between the first radiation part and the first plate part, each antenna structure includes a first short-circuit arm. In this way, the first radiation part and the first plate part are spaced away from each other, and the first side edge of the first radiation part is electrically connected to the first plate part through the first short-circuit arm. In addition, each antenna structure further includes a second short-circuit arm, and the second radiation part and the second plate part are spaced from each other. In this way, the second side edge of the second radiation part is electrically connected to the second plate part through the second short-circuit arm. In this way, when the first radiation part and the second radiation part are electrically connected to the corresponding plate parts, a radiation cavity may be formed among the first radiation part, the second radiation part, and the conductive plate, to implement radiation of a signal by the antenna structure.

A size of the first short-circuit arm is not specifically limited in this application. For example, in an arrangement direction from the first radiation part to the first plate part, a width of the first short-circuit arm is less than or equal to a length of the third side edge. Within the foregoing range, the width of the first short-circuit arm may be increased to improve bandwidth and efficiency of the antenna.

Similarly, in an arrangement direction from the second radiation part to the second plate part, a width of the second short-circuit arm is less than or equal to a length of the fourth side edge. Within the foregoing range, the width of the second short-circuit arm may be increased to improve bandwidth and efficiency of the antenna.

In a possible implementation of this application, each antenna structure further includes a feed line, a feed point is disposed on the second radiation part of each antenna structure, and the feed line is electrically connected to the corresponding feed point, to feed the antenna structure.

In this application, the feed line of each antenna structure is electrically connected to a feed source in a one-to-one correspondence, to feed corresponding antenna structures through different feed sources. In addition, signals fed by the corresponding feed sources into the antenna structures have a same frequency, so that the antenna can radiate a signal in a specific operating frequency band.

When the feed point is specifically disposed, the feed point and the fourth side edge are spaced away from each other, and in an extension direction of the fourth side edge, a distance deviation between the feed point and a middle position between two end parts of the fourth side edge is ±1 mm, to ensure symmetry of a current and a pattern of the antenna structure. In this way, radiation performance of the antenna structure is improved.

In a possible implementation of this application, the antenna includes three antenna structures, and the first direction is perpendicular to the second direction. In addition, the first antenna structure and the second antenna structure that are arranged in the first direction are symmetrically disposed relative to a first plane of symmetry, the first plane of symmetry passes through a center point of a spacing between the first antenna structure and the second antenna structure, and the first plane of symmetry is perpendicular to the first direction. The first antenna structure and the third antenna structure that are arranged in the second direction are symmetrically disposed relative to a second plane of symmetry, the second plane of symmetry passes through a center point of a spacing between the first antenna structure and the third antenna structure, and the second plane of symmetry is perpendicular to the second direction. In this way, angle measurement and ranging in the first direction may be performed through the two antenna structures arranged in the first direction, and angle measurement and ranging in the second direction may be performed through the two antenna structures arranged in the second direction, so that the antenna can position a to-be-measured object.

To improve deflection consistency of patterns of the first antenna structure and the second antenna structure that are arranged in the first direction, in a possible implementation of this application, the antenna may further include a conductive structure. The conductive structure includes a first conductive part and a second conductive part. The first conductive part is electrically connected to the first plate part, the second conductive part is electrically connected to the second plate part, and the second conductive part and second radiation parts of the antenna structures are located on a same side of the second plate part. In addition, the first conductive part and the first radiation part of the second antenna structure are symmetrically disposed relative to the second plane of symmetry, the first conductive part and the first radiation part of the third antenna structure are symmetrically disposed relative to the first plane of symmetry, the second conductive part and the second radiation part of the second antenna structure are symmetrically disposed relative to the second plane of symmetry, and the second conductive part and the second radiation part of the third antenna structure are symmetrically disposed relative to the first plane of symmetry. This can help improve accuracy of angle measurement and ranging in the first direction by the first antenna structure and the third antenna structure that are arranged in the first direction.

In addition, in this application, the second conductive part of the conductive structure and the second radiation parts of the antenna structures may also be disposed on a same plane, to help implement directional radiation of a signal by the antenna.

In a possible implementation of this application, a center spacing L2 between the first antenna structure and the third antenna structure that are arranged in the second direction satisfies: λ0/4≤L2≤λ0/2, where λ0 is the wavelength corresponding to the center frequency of the operating frequency band of the antenna in free space. This ensures angle measurement precision of the two antenna structures in the second direction.

When the antenna includes three antenna structures, the first antenna structure and the second antenna structure that are arranged in the first direction are symmetrically disposed relative to the first plane of symmetry, and the first antenna structure, the second antenna structure, and the third antenna structure are arranged in an isosceles triangle. Such an arrangement manner may also enable the first antenna structure and the third antenna structure that are arranged in the first direction to have a consistent pattern deflection manner, thereby ensuring positioning accuracy of the antenna.

In a possible implementation of this application, the antenna may further include four antenna structures, and a fourth antenna structure is centrosymmetrically disposed. In this way, the antenna may include two groups of antenna structures arranged in the first direction, and include two groups of antenna structures arranged in the second direction. Therefore, the two groups of antenna structures arranged in the first direction may perform angle measurement and ranging in the first direction, and the two groups of antenna structures arranged in the second direction may perform angle measurement and ranging in the second direction, so that positioning accuracy of the antenna can be improved.

In a possible implementation of this application, a center spacing L1 between the first antenna structure and the second antenna structure that are arranged in the first direction satisfies: λ0/4≤L1≤λ0/2, where λ0 is the wavelength corresponding to the center frequency of the operating frequency band of the antenna in free space. This ensures angle measurement precision of the two antenna structures in the first direction.

In a possible implementation of this application, the conductive plate includes a reflective surface that is continuously disposed, and a projection of the first radiation part of each antenna structure on the first plate part and a projection of the second radiation part of each antenna structure on the second plate part each fall within a contour range of the reflective surface. This can help improve a capability of directional radiation of a signal by the antenna.

According to a second aspect, this application further provides an electronic device. The electronic device includes a housing and the antenna in the first aspect. The electronic device may be but is not limited to a directional electronic device like as a remote control, a mobile phone, or a car key. Because a side surface of the housing may point to a to-be-measured object when this type of electronic device is used, and the antenna provided in this application has a small size, the antenna may be disposed in the housing of the electronic device. This helps improve use convenience of the electronic device.

In a possible implementation of this application, the second radiation part of each antenna structure is attached to a top side surface of the housing or spaced away from a top side surface of the housing, to implement directional radiation of a signal by the antenna in a direction perpendicular to the top side surface.

### BRIEF DESCRIPTION OF THE DRAWINGS

FIG. 1 is a diagram of a structure of a remote control provided with a UWB antenna according to an embodiment of this application;

FIG. 2 is a diagram of a partial structure of an antenna according to an embodiment of this application;

FIG. 3 is an A-direction view of the antenna shown in FIG. 2;

FIG. 4 is a diagram of a structure of an antenna according to an embodiment of this application;

FIG. 5 is a diagram of another structure of an antenna according to an embodiment of this application;

FIG. 6 is a diagram of a specific structure of an antenna according to an embodiment of this application;

FIG. 7 is a diagram of a partial structure of the antenna shown in FIG. 6;

FIG. 8 is a B-direction view of the antenna shown in FIG. 6;

FIG. 9 shows passive performance curves of three antenna structures of the antenna shown in FIG. 6;

FIG. 10 shows average efficiency curves of the three antenna structures of the antenna shown in FIG. 6 in an operating frequency band;

FIG. 11 shows a PDOA curve of a first antenna structure and a second antenna structure of the antenna shown in FIG. 6 at a horizontal azimuth;

FIG. 12 shows a PDOA curve of a first antenna structure and a third antenna structure of the antenna shown in FIG. 6 at a vertical azimuth;

FIG. 13 is a diagram of a structure of a remote control according to an embodiment of this application; and

FIG. 14 is an exploded view of the remote control shown in FIG. 13.

### REFERENCE NUMERALS:

100a: UWB antenna; 100b: antenna; 1: antenna structure; 1a: first antenna structure; 1011a: first radiation part of the first antenna structure;
1012a: second radiation part of the first antenna structure; 102a: first short-circuit arm of the first antenna structure;
103a: second short-circuit arm of the first antenna structure; 1b: second antenna structure; 1011b: first radiation part of the second antenna structure;
1012b: second radiation part of the second antenna structure; 1c: third antenna structure; 1011c: first radiation part of the third antenna structure;
1012c: second radiation part of the third antenna structure; 102c: first short-circuit arm of the third antenna structure;
103c: second short-circuit arm of the third antenna structure; 1d: conductive structure/dummy antenna structure; 101: radiator; 1011: first radiation part;
10111: first side edge; 10112: third side edge; 1012: second radiation part; 10121: second side edge; 10122: fourth side edge;
10123: feed point; 1013: first conductive part; 1014: second conductive part; 102: first short-circuit arm; 103: second short-circuit arm;
104: third short-circuit arm; 105: fourth short-circuit arm; 106: feed line; 2: conductive plate; 201: first plate part; 202: second plate part;
3: cavity structure; 4: dielectric substrate; 401: first surface; 402: second surface; 5: slot; 6: through hole;
200: housing; and 300: main board.

### DETAILED DESCRIPTION OF ILLUSTRATIVE EMBODIMENTS

To make the objectives, technical solutions, and advantages of this application clearer, the following further describes embodiments of this application in detail with reference to the accompanying drawings. However, example implementations may be implemented in a plurality of forms, and should not be construed as being limited to implementations described herein. Same reference numerals in the accompanying drawings indicate same or similar structures. Therefore, repeated description thereof is omitted. Expressions of positions and directions in embodiments of this application are described by using the accompanying drawings as an example. However, changes may also be made as required, and all the changes fall within the protection scope of this application. The accompanying drawings in embodiments of this application are merely used to illustrate a relative position relationship and do not represent an actual scale.

It should be noted that specific details are set forth in the following descriptions to facilitate understanding of this application. However, embodiments of this application can be implemented in a plurality of manners different from those described herein, and a person skilled in the art can perform similar generalization without departing from the connotation of embodiments of this application. Therefore, this application is not limited to the specific implementations disclosed below.

The limitations such as symmetrical, parallel, vertical, and same (for example, a same length and a same width) mentioned in embodiments of this application are all for a current process level, but are not absolutely strict definitions in a mathematical sense.

The following describes terms that may appear in embodiments of this application.

A feed source/feed circuit is a combination of all circuits configured to receive and transmit radio frequency signals. The feed circuit may include a transceiver and a radio frequency front end circuit (RF front end). In some cases, in a narrow sense, the “feed circuit” is a radio frequency chip (RFIC, Radio Frequency Integrated Circuit), and the RFIC may be considered to include a radio frequency front end chip and the transceiver. The feed circuit has a function of converting a radio wave (for example, a radio frequency signal) and an electrical signal (for example, a digital signal). Usually, the feed circuit is considered as a part of radio frequency.

In some embodiments, an electronic device may further include a test base (which is also referred to as a radio frequency base or a radio frequency test base). A coaxial cable may be inserted into the test base, to test a characteristic of the radio frequency front end circuit or a radiator of an antenna through the cable. The radio frequency front end circuit may be considered as a circuit part coupled between the test base and the transceiver.

In some embodiments, the radio frequency front end circuit may be integrated into the radio frequency front end chip in the electronic device, or the radio frequency front end circuit and the transceiver may be integrated into the radio frequency chip in the electronic device.

It should be understood that any two of a first feed circuit, a second feed circuit, . . . , and an Nth feed circuit in this application may share a same transceiver, for example, transmit a signal through a radio frequency channel in the transceiver (for example, a pin of the radio frequency chip), and may further share a radio frequency front end circuit, for example, process the signal through a switch or an amplifier in a radio frequency front end.

It should be further understood that two of the first feed circuit, the second feed circuit, . . . , and the Nth feed circuit in this application usually correspond to two radio frequency test bases in the electronic device.

A feed line, also referred to as a transmission line, is a connection line between a transceiver of an antenna and a radiator. The transmission line can directly transmit current waves or electromagnetic waves with different frequencies and forms. A connection point that is on the radiator and that is connected to the transmission line is usually referred to as a feed point. The transmission line includes a conducting-wire transmission line, a coaxial-line transmission line, a waveguide, a microstrip, or the like. The transmission line may include a bracketed antenna body, a glass antenna body, or the like based on different implementation forms. The transmission line may be implemented by using LCP (Liquid Crystal Polymer, liquid crystal polymer material), an FPC (Flexible Printed Circuit), a PCB (Printed Circuit Board), or the like based on different carriers.

Resonance frequency: The resonance frequency is also referred to as a resonant frequency. The resonance frequency may have a frequency range, namely, a frequency range in which resonance occurs. The resonance frequency may be a frequency range in which a return loss is less than −6 dB. A strongest resonance point may be referred to as a resonance point, and a frequency corresponding to the resonance point is a center frequency point frequency. A return loss of the center frequency may be less than −20 dB. It should be understood that, unless otherwise specified, an antenna/a radiator generates a “first/second . . . resonance” in this application, where the first resonance should be a fundamental mode resonance generated by the antenna/radiator, or a resonance that is generated by the antenna/radiator and that has a lowest frequency. It should be understood that the antenna/radiator may generate one or more antenna modes based on specific design, and one fundamental mode resonance may be correspondingly generated in each antenna mode.

Resonance frequency band: A range of a resonance frequency is the resonance frequency band, and a return loss of any frequency on the resonance frequency band may be less than −6 dB or −5 dB.

Communication frequency band/operating frequency band: Regardless of a type of antenna, the antenna constantly operates in a specific frequency range (a frequency band width). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna. A width of the operating frequency band is referred to as an operating bandwidth. An operating bandwidth of an omnidirectional antenna may reach 3% to 5% of the center frequency. An operating bandwidth of a directional antenna may reach 5% to 10% of the center frequency. The bandwidth may be considered as a range of frequencies on both sides of the center frequency (for example, a resonance frequency of a dipole), where an antenna characteristic is within an acceptable range of values for the center frequency.

The resonance frequency band and the operating frequency band may be the same, or may partially overlap. In an embodiment, one or more resonance frequency bands of the antenna may cover one or more operating frequency bands of the antenna.

Antenna return loss: The antenna return loss may be understood as a ratio of power of a signal reflected back to an antenna port through an antenna circuit to transmit power of the antenna port. A smaller reflected signal indicates a greater signal radiated by an antenna to space and higher radiation efficiency of the antenna. A greater reflected signal indicates a smaller signal radiated by the antenna to space and lower radiation efficiency of the antenna.

The antenna return loss may be represented by an S11 parameter, and S11 is one of the S parameters. S11 indicates a reflection coefficient, and the parameter can represent transmit efficiency of the antenna.

In an embodiment, an S11 diagram may be understood as a diagram of resonance generated by the antenna. In an embodiment, a part that is of the resonance shown in the S11 diagram and that is less than −6 dB may be understood as a resonance frequency/a frequency range/an operating frequency band generated by the antenna. The S11 parameter is usually a negative number. A smaller S11 parameter indicates a smaller antenna return loss, less energy reflected back by the antenna, namely, more energy that actually enters the antenna, and higher system efficiency of the antenna. A greater S11 parameter indicates a greater antenna return loss and lower system efficiency of the antenna.

It should be noted that −4 dB may be used as a standard value of S11. When the value of S11 of the antenna is less than −4 dB, it may be considered that the antenna can operate normally. It should be understood that, −6 dB may alternatively be used as a standard value of S11 in engineering. When the value of S11 of the antenna is less than −6 dB, it may be considered that transmit efficiency of the antenna is good.

To facilitate understanding of antenna provided in embodiments of this application, the following describes an application scenario of the antenna. The antenna provided in embodiments of this application may be used in an electronic device, so that the electronic device can receive or send a wireless signal, to implement a communication function of the electronic device.

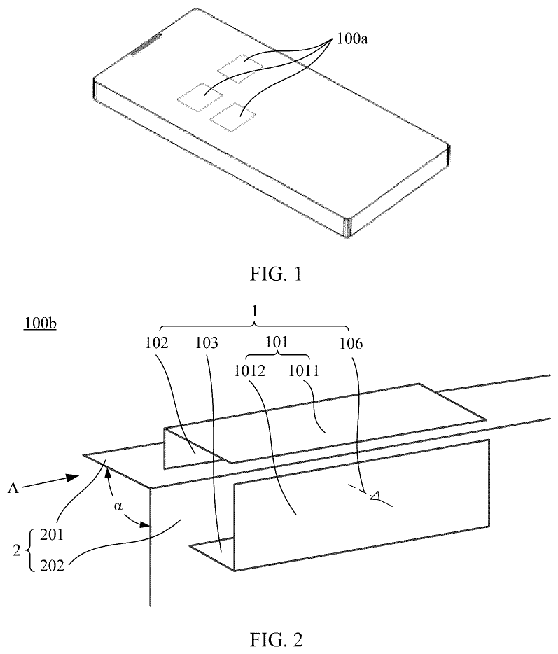

With gradual maturation of communication technologies, position-based services are increasingly vital for enhancing convenience of people's daily life. For example, a common indoor positioning technology currently includes a Wi-Fi (wireless-fidelity) technology, a Bluetooth technology, a ZigBee technology, a UWB technology, and the like. Because the UWB technology has advantages such as high positioning accuracy, a strong anti-interference capability, a high operating frequency, a small size, and low power consumption, the UWB technology has been increasingly used in the electronic device in recent years, especially in a handheld electronic device. A remote control is used as an example. FIG. 1 is a diagram of a structure of a remote control provided with a UWB antenna according to an embodiment of this application. Currently, a UWB antenna 100a may be usually set in a form of microstrip patch antenna or a variant form of microstrip patch antenna. To implement a positioning function of a remote control, a plurality of UWB antennas 100a usually need to be disposed in the remote control, so that angle measurement and ranging are performed by using a phase difference between signals that are from a to-be-measured object and that are received by two adjacent UWB antennas 100a, to implement the positioning function of the remote control.

Currently, the remote control usually has a small thickness size due to a design requirement for lightness and thinness. However, an existing UWB antenna 100a has a large size. Therefore, as shown in FIG. 1, the UWB antenna 100a may be usually disposed only on a back of the remote control, that is, disposed on a side that is of the remote control and that is opposite to a surface on which a button is disposed. In this case, in an actual use process of the remote control, angle measurement and ranging can only be performed by pointing the back of the remote control toward the to-be-measured object. This affects use convenience of the remote control.

In view of this, embodiments of this application provide an antenna. A conductive plate includes two plate parts that are disposed at a specified angle, and two radiation parts of a radiator are respectively disposed on the two plate parts of the conductive plate, to effectively reduce a size of the antenna without affecting radiation performance of the antenna. In this way, the antenna can meet a requirement of being disposed on a side surface of an electronic device, to improve flexibility of disposing the antenna in the electronic device. This helps improve use convenience of the electronic device. To make the objectives, technical solutions, and advantages of this application clearer, the following further describes this application in detail with reference to the accompanying drawings and specific embodiments.

FIG. 2 is a diagram of a partial structure of an antenna 100b according to an embodiment of this application. In this embodiment of this application, the antenna 100b includes an antenna structure 1 and a conductive plate 2. The antenna structure 1 includes a radiator 101. The radiator 101 may also be referred to as an antenna element, an element, or the like. The radiator 101 is a unit that constitutes a basic structure of the antenna, and can effectively radiate or receive a radio wave.

In an embodiment, the conductive plate 2 may also be referred to as a reflection plate, a bottom plate, an antenna panel, a metal reflection surface, or the like. The conductive plate 2 can improve radiation directivity of an antenna signal, for example, implement directional radiation of the antenna signal, to improve radiation performance of the antenna, so as to improve sensitivity of the antenna. The radiator 101 is usually disposed on a surface of one side of the conductive plate 2. This can greatly enhance a signal receiving or transmitting capability of the antenna, and can further block and shield interference of another radio wave from a surface of the other side of the conductive plate 2 to signal receiving.

In this application, a material of the conductive plate 2 may be copper, aluminum, stainless steel, brass, or an alloy thereof, or may be another material having conductive performance. When the conductive plate 2 is specifically disposed, still refer to FIG. 2. The conductive plate 2 includes a first plate part 201 and a second plate part 202. An edge of the first plate part 201 is connected to an edge of the second plate part 202, and the first plate part 201 and the second plate part 202 are not disposed on a same plane. In this case, there is a first included angle a between the first plate part 201 and the second plate part 202, and first included angle a is less than 180°. For example, the first included angle a may be 90°±30°. Further, the first plate part 201 and the second plate part 202 may be disposed perpendicularly, and the first included angle a is 90°. However, in an actual processing process, due to a limitation of a process level, the first included angle a may be 90°±5°, for example, 85°, 92°, or 95°.

In this embodiment of this application, how the first plate part 201 is connected to the second plate part 202 is not limited. For example, the conductive plate 2 may be of an integrally formed structure. In this case, the first plate part 201 and the second plate part 202 may be formed by bending a same plate-shaped structure, or may be obtained through processing by using a same etching or coating process, to reduce impedance between the first plate part 201 and the second plate part 202, and effectively simplify a structure of the conductive plate 2. In some other possible embodiments of this application, the first plate part 201 and the second plate part 202 may alternatively be two independent structures, and are connected to each other through bonding, welding, or the like, to dispose the first plate part 201 and the second plate part 202 more flexibly.

The radiator 101 of the antenna structure 1 provided in this embodiment of this application also includes two parts: a first radiation part 1011 and a second radiation part 1012. As shown in FIG. 2, both the first radiation part 1011 and the second radiation part 1012 are located on a side that is of the conductive plate 2 and that is away from the first included angle α, the first radiation part 1011 is electrically connected to the first plate part 201, and the second radiation part 1012 is electrically connected to the second plate part 202.

Because the radiator 101 may usually be a conductor having a specific shape and size, for example, a linear radiator or a sheet-shaped radiator, in this embodiment of this application, the radiator 101 may be specifically a sheet-shaped radiator 101. In this case, both the first radiation part 1011 and the second radiation part 1012 of the radiator 101 may be sheet-shaped radiation parts. The sheet-shaped radiation part may be a common patch or a metasurface patch (Meta Patch). For example, the first radiation part 1011 and the second radiation part 1012 may be set as metal sheets having conductive performance, for example, copper sheets. In a possible embodiment, the first radiation part 1011 and the second radiation part 1012 may be set as conductive coatings. In addition, shapes of the first radiation part 1011 and the second radiation part 1012 are not specifically limited in embodiments of this application, and may be set to regular shapes such as rectangles.

In an embodiment, materials of the conductive plate 2 and the radiator 101 may be the same, and thicknesses of the conductive plate 2 and the radiator 101 may be similar. In addition, the conductive plate 2 and the radiator 101 may be obtained through processing by using a same etching or coating process, to simplify an antenna processing process.

It should be noted that, in this embodiment of this application, the conductive plate 2 may include a reflective surface that is continuously disposed, and a projection of the first radiation part 1011 on the first plate part 201 and a projection of the second radiation part 1012 on the second plate part 202 each fall within a contour range of the reflective surface that is continuously disposed on the conductive plate 2. Therefore, the conductive plate 2 can improve performance of directional radiation of a signal by the antenna structure 1, and enable the antenna structure 1 to radiate a signal in a specific operating frequency band.

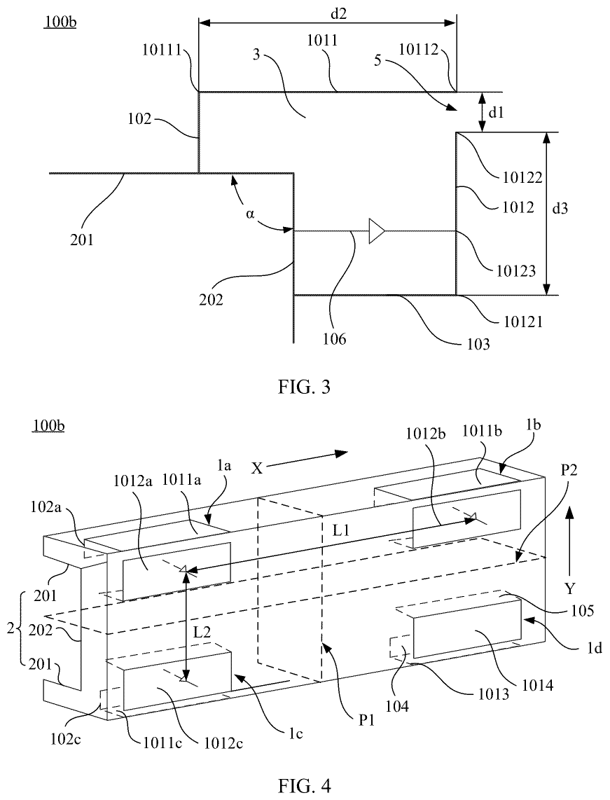

FIG. 3 is an A-direction view of the antenna shown in FIG. 2. When the first radiation part 1011 is electrically connected to the first plate part 201, the first radiation part 1011 may include a first side edge 10111 and a third side edge 10112 that are disposed opposite to each other, where the first side edge 10111 is electrically connected to the first plate part 201, and the third side edge 10112 is closer to the second radiation part 1012 than the first side edge 10111.

When the second radiation part 1012 is electrically connected to the second plate part 202, the second radiation part 1012 includes a second side edge 10121 and a fourth side edge 10122 that are disposed opposite to each other, where the second side edge 10121 is electrically connected to the second plate part 202, and the fourth side edge 10122 is closer to the first radiation part 1011 than the second side edge 10121.

In addition, to implement radiation and receiving of a signal by the radiator 101, a cavity structure 3 further needs to be formed between the radiator 101 and the conductive plate 2. Based on this, the first radiation part 1011 and the first plate part 201 are spaced away from each other, and the second radiation part 1012 and the second plate part 202 are spaced away from each other. The antenna structure 1 may further include a first short-circuit arm 102 and a second short-circuit arm 103. In this case, the first side edge 10111 of the first radiation part 1011 is electrically connected to the first radiation part 1011 through the first short-circuit arm 102, and the third side edge 10112 of the second radiation part 1012 is electrically connected to the second radiation part 1012 through the second short-circuit arm 103.

In this application, the first short-circuit arm 102 and the second short-circuit arm 103 may alternatively be conductors having specific shapes and sizes. For example, the first short-circuit arm 102 and the second short-circuit arm 103 may be set to be linear or sheet-shaped. In the antenna 100b shown in FIG. 2, both the first short-circuit arm 102 and the second short-circuit arm 103 are set to be sheet-shaped, and may be set as metal sheets having conductive performance, such as copper sheets, or may be set as conductive coatings. In addition, the first short-circuit arm 102 and the first radiation part 1011 may be made of a same material or different materials. When the first short-circuit arm 102 and the first radiation part 1011 are made of a same material, the first short-circuit arm 102 and the first radiation part 1011 may be of an integrally formed structure. For example, the first short-circuit arm 102 and the first radiation part 1011 may be formed by bending a same plate-shaped structure, or may be of an integrated structure processed and formed by using an etching or coating process, to effectively simplify a processing process of the antenna 100b and improve production efficiency of the antenna 100b.

Similarly, the second short-circuit arm 103 and the second radiation part 1012 may be made of a same material or different materials. When the second short-circuit arm 103 and the second radiation part 1012 are made of a same material, the second short-circuit arm 103 and the second radiation part 1012 may also be formed by bending a same plate-shaped structure, or may be of an integrated structure processed and formed by using an etching or coating process, to simplify a processing process of the antenna 100b and improve production efficiency of the antenna 100b.

It should be noted that a dielectric substrate (not shown in FIG. 2 and FIG. 3) may be further filled in the cavity structure 3 enclosed by the radiator 101 and the conductive plate 2. A material of the dielectric substrate 4 is not limited in this application. For example, the dielectric substrate 4 may be acrylonitrile butadiene styrene (ABS) plastic or polyphenylene sulfide (PPS).

Generally, a smaller dielectric constant of the dielectric substrate 4 corresponds to a smaller dielectric wavelength, which is more conducive to reducing an antenna size. Therefore, in the antenna provided in this embodiment of this application, the dielectric constant of the dielectric substrate 4 may be 2.0 to 6.0, for example, may be 4.0. In addition, in this application, a dielectric loss of the dielectric substrate 4 may be less than or equal to 0.005, so that efficiency of the antenna can be effectively improved.

Still refer to FIG. 3. In this application, the third side edge 10112 of the first radiation part 1011 and the fourth side edge 10122 of the second radiation part 1012 are spaced away from each other. Therefore, a slot 5 may be formed between the third side edge 10112 and the fourth side edge 10122, and the radiator 101 may radiate and receive a signal through the slot 5.

Because a frequency offset of the antenna structure 1 may be adjusted by adjusting a spacing between the third side edge 10112 and the fourth side edge 10122, in this application, the spacing di between the third side edge 10112 and the fourth side edge 10122 may satisfy: 0.02λ≤d1≤0.04λ, and may be 0.025λ during actual application, where λ is a dielectric wavelength corresponding to a center frequency of an operating frequency band of the antenna. For example, when the center frequency of the operating frequency band of the antenna 100b is about 8 GHz, the spacing between the third side edge 10112 and the fourth side edge 10122 may be 0.5 mm. It may be understood that, in this embodiment of this application, the third side edge 10112 and the fourth side edge 10122 may be disposed in parallel. This helps improve a pattern parameter of the radiator 101, thereby improving radiation performance of the antenna 100b.

It may be understood from the foregoing descriptions of the first radiation part 1011 and the second radiation part 1012 of the radiator 101 that a plane on which the first radiation part 1011 is located intersects with a plane on which the second radiation part 1012 is located. An included angle between the plane on which the first radiation part 1011 is located and the plane on which the second radiation part 1012 is located is not limited in this application. For example, in the antenna shown in FIG. 3, the first radiation part 1011 and the second radiation part 1012 may be orthogonally disposed, and the plane on which the first radiation part 1011 is located is perpendicular to the plane on which the second radiation part 1012 is located. Further, it can be learned from the foregoing descriptions of the first plate part 201 and the second plate part 202 of the conductive plate 2 that the first plate part 201 and the second plate part 202 may alternatively be perpendicularly disposed. In this case, in this application, the plane on which the first radiation part 1011 is located may be disposed in parallel to the first plate part 201, and the plane on which the second radiation part 1012 is located may be disposed in parallel to the second plate part 202.

Still refer to FIG. 3. In this application, the first short-circuit arm 102 may be perpendicular to the first plate part 201. In addition, in an arrangement direction from the first radiation part 1011 to the first plate part 201, a width of the first short-circuit arm 102 is far less than a wavelength corresponding to the center frequency of the operating frequency band of the antenna 100b in free space. For example, the width of the first short-circuit arm 102 may be less than or equal to a length of the third side edge 10112. In an embodiment, resonance generated by the antenna 100b may be used to cover 8 GHz. Alternatively, when the operating frequency band of the antenna 100b covers 8 GHz, the width of the first short-circuit arm 102 may be less than or equal to 1.5 mm, for example, may be 1 mm, 1.2 mm, or 1.4 mm.

In addition, the second short-circuit arm 103 may be perpendicular to the second plate part 202. In addition, in an arrangement direction from the second radiation part 1012 to the second conductive plate 2, a width of the second short-circuit arm 103 is far less than the wavelength corresponding to the center frequency of the operating frequency band of the antenna 100b in free space. In an embodiment, resonance generated by the antenna 100b may be used to cover 8 GHz. Alternatively, when the operating frequency band of the antenna 100b covers 8 GHz, a length of the second short-circuit arm 103 may be less than or equal to 1.5 mm. For example, the width of the second short-circuit arm 103 may be less than or equal to a length of the fourth side edge 10122. In an embodiment, resonance generated by the antenna 100b may be used to cover 8 GHz. Alternatively, when the operating frequency band of the antenna 100 b covers 8 GHz, the width of the second short-circuit arm 103 may be less than or equal to 1.5 mm, for example, may be 1 mm, 1.2 mm, or 1.4 mm. It should be noted that, within a specific range, as the width of the first short-circuit arm 102 and the width of the second short-circuit arm 103 increase, bandwidth and efficiency of the antenna 100b may be improved to a specific extent.

Because a positioning function of the antenna 100b is implemented based on directional radiation of a signal by the radiator 101, in this application, an opening direction of the slot 5 between the first radiation part 1011 and the second radiation part 1012 may be adjusted, to implement the directional radiation of the signal by the radiator 101. For example, in the antenna shown in FIG. 3, the third side edge 10112 of the first radiation part 1011 is located on the plane on which the second radiation part 1012 is located. In this case, an opening of the slot 5 is provided in a direction in which the second plate part 202 and the second radiation part 1012 are arranged. In this case, the signal may be radiated from the slot 5 to a side that is of the second plate part 202 and that is away from the second radiation part 1012. In actual application, the opening direction of the slot 5 may be consistent with a pointing direction of the electronic device during use, to help improve use convenience of the electronic device and improve positioning accuracy of the antenna.

In this application, a width d2 of the first radiation part 1011 from the first side edge 10111 to the third side edge 10112 and a width d3 of the second radiation part 1012 from the second side edge 10121 to the fourth side edge 10122 satisfy: d2/d3=0.8 to 1.2. In a specific implementation, the first radiation part 1011 and the second radiation part 1012 may be symmetrically disposed relative to the slot 5. In this case, the width d2 of the first radiation part 1011 from the first side edge 10111 to the third side edge 10112 is equal to the width d3 of the second radiation part 1012 from the second side edge 10121 to the fourth side edge 10122, to improve symmetry of the antenna structure 1, and improve symmetry of a pattern of the antenna structure 1. In addition, the length of the third side edge 10112 of the first radiation part 1011 may be equal to the length of the fourth side edge 10122 of the second radiation part 1012, to further improve symmetry of the antenna structure 1. This can effectively improve symmetry of the pattern of the antenna structure 1, to improve radiation performance of the antenna structure 1.

In addition, in this embodiment of this application, the length of the third side edge 10112 of the first radiation part 1011 may be less than or equal to d1+d2+d3, and the length of the fourth side edge 10122 of the second radiation part 1012 may be less than or equal to d1+d2+d3. In a possible embodiment of this application, λ0/4≤d1+d2+d3≤λ0/2, where λ0 is a wavelength corresponding to the center frequency of the operating frequency band of the antenna 100b in free space, to ensure that the antenna can operate in a required frequency band.

Still refer to FIG. 2 and FIG. 3. The antenna structure 1 further includes a feed line 106. The feed line 106 may be configured to feed the radiator 101. The feed line 106, also referred to as a transmission line, is a connection line between a transceiver of the antenna and the radiator. The feed line 106 may directly transmit current waves or electromagnetic waves with different frequencies and forms. A type of the feed line 106 is not limited in this application. For example, the feed line 106 may be a coaxial line, a waveguide, or a microstrip line, to implement direct feeding or coupled feeding of the feed line 106 to the radiator 101.

Because both the first radiation part 1011 and the second radiation part 1012 are electrically connected to the conductive plate 2, in this application, the feed line 106 may be electrically connected to one of the first radiation part 1011 and the second radiation part 1012, and may be selected based on layout space between each of the first radiation part 1011 and the second radiation part 1012 and the conductive plate 2. For example, in the antenna shown in FIG. 3, an area of a part that is of the second plate part 202 and that is used to form the cavity structure 3 is greater than an area of a part that is of the first plate part 201 and that is used to form the cavity structure 3. In this case, the feed line 106 may pass through the part that is of the second plate part 202 and that is used to form the cavity structure 3, to be electrically connected to the second radiation part 1012.

When the feed line 106 is electrically connected to the second radiation part 1012, the second radiation part 1012 may be provided with a feed point 10123, and the feed line 106 may be electrically connected to the feed point 10123. The feed point 10123 may be spaced away from the fourth side edge 10122. In this embodiment of this application, a spacing between the feed point 10123 and the fourth side edge 10122 bracket is not limited. In addition, in an extension direction of the fourth side edge 10122, the feed point 10123 may be located at a position corresponding to a midpoint between two end parts of the fourth side edge 10122 of the second radiation part 1012, to ensure symmetry of a current and a pattern of the antenna structure 1, so as to improve radiation performance of the antenna structure 1. However, in an actual processing process, due to a limitation of a process level, in the extension direction of the fourth side edge 10122, a distance deviation between the feed point 10123 and the middle position of the two end parts of the fourth side edge 10122 may be ±1 mm.

According to the antenna 100b provided in this embodiment of this application, the conductive plate 2 includes the first plate part 201 and the second plate part 202 that are disposed at a specified included angle, and the first radiation part 1011 and the second radiation part 1012 of the radiator 101 are respectively connected to one plate part of the conductive plate 2, so that a radiation gap is formed between the first radiation part 1011 and the second radiation part 1012. In this way, while the directional radiation of the signal by the antenna 100b is implemented, a projection area of the antenna 100b on the plane on which the first radiation part 1011 is located and a projection area of the antenna 100b on the plane on which the second radiation part 1012 is located are both small. Therefore, when the antenna 100b is used in an electronic device, the antenna 100b can meet a requirement of being disposed on a side surface of the electronic device, to improve flexibility of disposing the antenna 100b in the electronic device, and improve use convenience of the electronic device.

It may be understood from the foregoing description of the antenna positioning principle that the antenna 100b provided in this embodiment of this application may include a plurality of antenna structures 1, to perform angle measurement and ranging by using a phase difference between signals that are from a to-be-measured object and that are received by two adjacent antenna structures 1, so as to implement a positioning function of the antenna 100b. In addition, it may be understood that, to implement spatial positioning, the antenna 100b may include at least three antenna structures 1. During a specific implementation, FIG. 4 is a diagram of a structure of the antenna 100b according to an embodiment of this application. The antenna 100b includes three antenna structures. Two antenna structures are arranged in a first direction X, and two antennas are arranged in a second direction Y. The first direction X is perpendicular to the second direction Y. For ease of description, in this embodiment of this application, the three antenna structures of the antenna are respectively denoted as a first antenna structure 1a, a second antenna structure 1b, and a third antenna structure 1c.

It can be learned from FIG. 4 that the second radiation part 1012a of the first antenna structure, the second radiation part 1012b of the second antenna structure, and the second radiation part 1012c of the third antenna structure may be located on a same side of the second plate part 202. In an embodiment of this application, the second radiation part 1012a of the first antenna structure, the second radiation part 1012b of the second antenna structure, and the second radiation part 1012c of the third antenna structure may be disposed on a same plane, to improve a capability of the antenna to perform directional radiation on a signal.

In an embodiment, in the first antenna structure 1a and the second antenna structure 1b that are arranged in the first direction X, a length, a width, and a thickness of a corresponding radiation part each have a difference less than 10%. In an embodiment, an insulation hole or an insulation gap may be provided on the radiation part of the first antenna structure 1a and/or the radiation part of the second antenna structure 1b, and a length, a width, and a thickness of the radiation part should be considered from the perspective of the radiation part as a whole, and are not affected by shapes and a quantity of insulation holes or insulation gaps.

In an embodiment, the first antenna structure 1a and the second antenna structure 1b that are arranged in the first direction X are symmetrically disposed relative to a first plane of symmetry P1, where the first plane of symmetry P1 passes through a center point of a spacing between the first antenna structure 1a and the second antenna structure 1b, and the first plane of symmetry P1 is perpendicular to the first direction X. In actual application, the first direction X may be a horizontal direction, and the first antenna structure 1a and the second antenna structure 1b may be configured to perform angle measurement and ranging on the to-be-measured object in the horizontal direction.

In this embodiment of this application, that the two antenna structures are symmetrically disposed relative to the plane of symmetry should be understood as that peripheral contours of the radiation parts of the two antenna structures are approximately symmetrical relative to the preset plane of symmetry, and are not affected by shapes and a quantity of insulation holes or insulation gaps provided in the contours.

In this embodiment of this application, a center spacing L1 between the first antenna structure 1a and the second antenna structure 1b satisfies: λ0/4≤L1≤λ0/2, to ensure angle measurement precision of the first antenna structure 1a and the second antenna structure 1b in the horizontal direction. Herein, do is a wavelength corresponding to a center frequency of an operating frequency band of the antenna 100b in free space. In addition, the center spacing L1 between the first antenna structure 1a and the second antenna structure 1b is a spacing between a feed point of the first antenna structure 1a and a feed point of the second antenna structure 1b.

Still refer to FIG. 4. In an embodiment, in the first antenna structure 1a and the third antenna structure 1c that are arranged in the second direction Y, a length, a width, and a thickness of a corresponding radiation part each have a difference less than 10%. In an embodiment, an insulation hole or an insulation gap may be provided on the radiation part of the first antenna structure 1a and/or the third antenna structure 1c, and the length, the width, and the thickness of the radiation part should be considered from the perspective of the radiation part as a whole, and are not affected by shapes and a quantity of insulation holes or insulation gaps.

The first antenna structure 1a and the third antenna structure 1c that are arranged in the second direction Y are symmetrically disposed relative to a second plane of symmetry P2, where the second plane of symmetry P2 passes through a center point of a spacing between the first antenna structure 1a and the third antenna structure 1c, and the second plane of symmetry P2 is perpendicular to the second direction Y. In actual application, the second direction Y may be a vertical direction, and the first antenna structure 1a and the third antenna structure 1c may be configured to perform angle measurement and ranging on the to-be-measured object in the vertical direction. In this embodiment of this application, a center spacing L2 between the first antenna structure 1a and the third antenna structure 1c satisfies: λ0/4≤L2≤o/2, to ensure angle measurement precision of the first antenna structure 1a and the third antenna structure 1c in the vertical direction. Herein, λ0 is a wavelength corresponding to a center frequency of an operating frequency band of the antenna 100b in free space. In addition, the center spacing L2 between the first antenna structure 1a and the third antenna structure 1c is a spacing between a feed point of the first antenna structure 1a and a feed point of the third antenna structure 1c.

It may be understood that, because the first antenna structure 1a and the third antenna structure 1c are symmetrically disposed relative to the second plane of symmetry P2, in the antenna 100b provided in this embodiment of this application, the conductive plate 2 may include two first plate parts 201, and the two first plate parts 201 are symmetrically disposed relative to the second plane of symmetry P2. Therefore, a first short-circuit arm 102a of the first antenna structure and a first short-circuit arm 102c of the third antenna structure may be electrically connected to one first plate part 201 separately.

Because the first antenna structure 1a and the third antenna structure 1c are close to each other, to ensure consistency of patterns of the first antenna structure 1a and the second antenna structure 1b, the antenna 100b shown in FIG. 4 further includes a conductive structure 1d. No feed line is disposed in the conductive structure 1d. In other words, the conductive structure 1d is not used for signal radiation. In the following embodiments of this application, the conductive structure id that is not connected to a feed line may also be referred to as a dummy antenna structure 1d.

Still refer to FIG. 4. The conductive structure 1d includes a first conductive part 1013 and a second conductive part 1014. The first conductive part 1013 is electrically connected to the first plate part 201 through a third short-circuit arm 104, and the second conductive part 1014 is electrically connected to the second plate part 202 through a fourth short-circuit arm 105. It should be noted that each radiation part of the three antenna structures of the antenna 100b and each conductive part of the conductive structure id are electrically connected to a same conductive plate 2.

In an embodiment, lengths, widths, and thicknesses of the first conductive part 1013 of the conductive structure id and the first radiation part 1011b of the second antenna structure each have a difference less than 10%, and lengths, widths, and thicknesses of the first conductive part 1013 of the conductive structure id and the first radiation part 1011c of the third antenna structure each have a difference less than 10%. In an embodiment, lengths, widths, and thicknesses of the second conductive part 1014 of the conductive structure 1d and the second radiation part 1012b of the second antenna structure each have a difference less than 10%, and lengths, widths, and thicknesses of the second conductive part 1014 of the conductive structure 1d and the second radiation part 1012c of the third antenna structure each have a difference less than 10%.

Similarly, an insulation hole or an insulation gap may be provided on the first conductive part 1013 and/or the second conductive part 1014 of the conductive structure 1d. The length, the width, and the thickness of the conductive part should be considered from the entire conductive part, and are not affected by shapes and a quantity of insulation holes or insulation gaps.

In an embodiment, the first conductive part 1013 of the conductive structure id and the first radiation part 1011b of the second antenna structure are symmetrically disposed relative to the second plane of symmetry P2, and the first conductive part 1013 of the conductive structure 1d and the first radiation part 1011c of the third antenna structure are symmetrically disposed relative to the first plane of symmetry P1. In an embodiment, the second conductive part 1014 of the conductive structure id and the second radiation part 1012b of the second antenna structure are symmetrically disposed relative to the second plane of symmetry P2, and the second conductive part 1014 of the conductive structure id and the second radiation part 1012c of the third antenna structure are symmetrically disposed relative to the first plane of symmetry P1.

In this embodiment of this application, that the conductive part of the conductive structure and the radiation part of the antenna structure are symmetrically disposed relative to the plane of symmetry should be understood as that peripheral contours of the conductive part of the conductive structure and the radiation part of the antenna structure are approximately symmetrical relative to the preset plane of symmetry, and are not affected by shapes and a quantity of insulation holes or insulation gaps provided in the contours.

In the antenna 100b shown in FIG. 4, symmetrically arranging the three antenna structures and the conductive structure id can ensure consistency of patterns of the first antenna structure 1a and the second antenna structure 1b, so that a deflection manner of the pattern of the first antenna structure 1a is the same as that of the pattern of the second antenna structure 1b. This can help improve angle measurement and ranging accuracy of the antenna 100b in the first direction X, and further improve positioning accuracy of the antenna 100b. In addition, symmetrically arranging the three antenna structures and the conductive structure 1d of the antenna 100b can further help simplify algorithm calculation difficulty of positioning of the antenna 100b.

Based on the foregoing description of the antenna 100b shown in FIG. 4, in a possible embodiment of this application, the antenna 100b may alternatively include four same antenna structures. In this case, it may be understood that the conductive structure id in FIG. 4 is alternatively replaced with the antenna structure 1 shown in FIG. 2. In this way, the four antenna structures may be centrosymmetrically disposed. Specifically, the four antenna structures include two groups of antenna structures symmetrically disposed relative to the first plane of symmetry P1 and two groups of antenna structures symmetrically disposed relative to the second plane of symmetry P2. The two groups of antenna structures symmetrically disposed relative to the first plane of symmetry P1 perform angle measurement and ranging in the first direction X, and the two groups of antenna structures symmetrically disposed relative to the second plane of symmetry P2 perform angle measurement and ranging in the second direction Y. This can effectively improve positioning accuracy of the antenna 100b for a to-be-measured object.

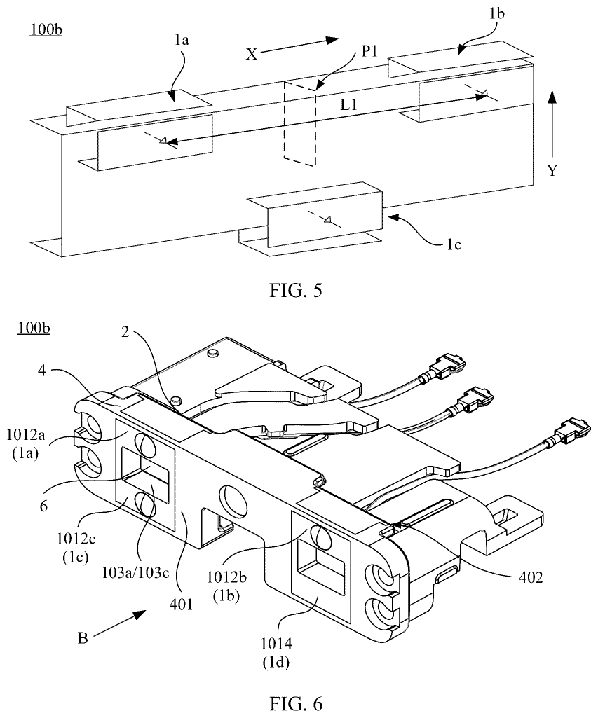

It can be learned from the foregoing description of the positioning principle of the antenna 100b that the antenna structures of the antenna 100b are symmetrically arranged, so that consistency of deflection manners of the patterns of the first antenna structure 1a and the second antenna structure 1b can be effectively ensured. In this way, angle measurement and ranging accuracy of the antenna 100b in the first direction X can be high. Based on this, refer to FIG. 5. FIG. 5 is a diagram of another structure of the antenna 100b according to an embodiment of this application. Compared with the antenna 100b shown in FIG. 4, the antenna 100b shown in FIG. 5 is not provided with the conductive structure 1d. In addition, in FIG. 5, the first antenna structure 1a and the second antenna structure 1b are symmetrically disposed relative to the first plane of symmetry P1, and the first antenna structure 1a, the second antenna structure 1b, and the third antenna structure 1c are arranged in an isosceles triangle. For other structures of the first antenna structure 1a, the second antenna structure 1b, and the third antenna structure 1c, refer to FIG. 4. Details are not described herein again.

In the antenna 100b shown in FIG. 5, a center spacing L1 between the first antenna structure 1a and the second antenna structure 1b satisfies: λ0/4≤L1≤λ0/2, where λ0 is a wavelength corresponding to a center frequency at which the antenna operates in free space. In this case, the first antenna structure 1a and the second antenna structure 1b may be configured to perform angle measurement and ranging in the first direction X. The first antenna structure 1a and the third antenna structure 1c, or the second antenna structure 1b and the third antenna structure 1c may be configured to perform angle measurement and ranging in the second direction Y.

Because the first antenna structure 1a and the second antenna structure 1b are affected by the third antenna structure 1c in the same manner, accuracy of angle measurement and ranging of the antenna 100b in the first direction X can be ensured. In addition, because the antenna structure of the antenna 100b shown in FIG. 5 includes only the first antenna structure 1a, the second antenna structure 1b, and the third antenna structure 1c, the structure of the antenna 100b is simplified.

In this application, an arrangement manner of each antenna structure of the antenna 100b provided in this application is described by using the antenna 100b shown in FIG. 4 and FIG. 5 as an example. However, the arrangement manner of each antenna structure of the antenna 100b is not limited thereto, and should be understood as falling within the protection scope of this application, provided that deflection consistency of patterns of the first antenna structure 1a and the second antenna structure 1b can be ensured. Details are not listed one by one herein.

A design principle of the antenna 100b provided in this application is described above. To further understand the antenna 100b provided in this application, the following describes an example of a size and performance of the antenna 100b in actual application.

FIG. 6 is a diagram of a specific structure of the antenna 100b according to an embodiment of this application. The antenna 100b shown in FIG. 6 is disposed in a manner in actual application based on the design principle of the antenna 100b shown in FIG. 4. In another possible application scenario, the antenna 100b may alternatively be specifically disposed in another manner, which should be understood as falling within the protection scope of this application. Details are not listed one by one herein.

Because a printed circuit board usually includes a conductive layer and a dielectric layer, the antenna 100b provided in this application mainly includes a conductive part and a dielectric substrate. Based on this, the antenna 100b shown in FIG. 6 may be disposed based on a structure of the printed circuit board. The conductive plate 2, the first antenna structure 1a, the second antenna structure 1b, the third antenna structure 1c, and the conductive structure 1d that are of the antenna 100b may be all obtained by processing the conductive layer on the printed circuit board by using an etching or coating process. The second radiation part 1012a of the first antenna structure, the second radiation part 1012b of the second antenna structure, the second radiation part 1012c of the third antenna structure, and the second conductive part 1014 of the conductive structure id are disposed on a first side surface 401 of the dielectric layer of the printed circuit board, and the conductive plate 2 is disposed on a second side surface 402 of the dielectric layer. The first side surface 401 and the second side surface 402 are disposed opposite to each other. In this case, the dielectric layer of the printed circuit board may be used as the dielectric substrate 4 of the antenna 100b.

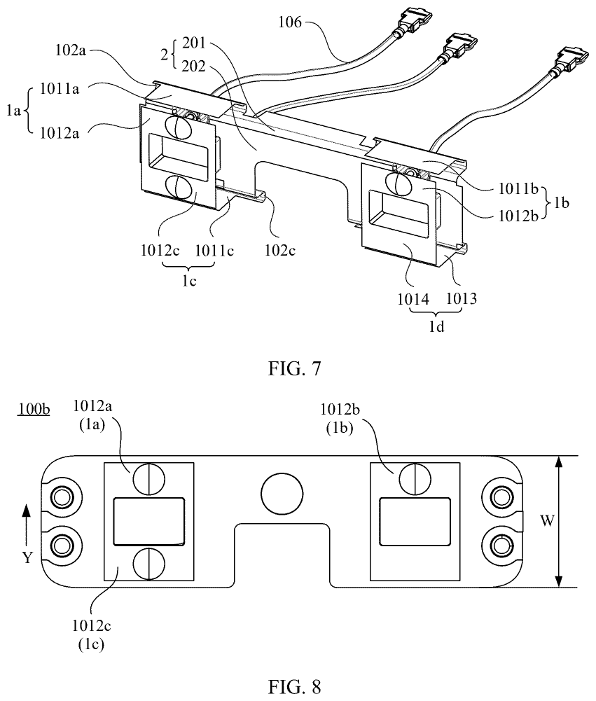

For ease of describing the conductive part of the antenna 100b, refer to FIG. 7. FIG. 7 shows only the conductive part of the antenna 100b shown in FIG. 6. Because the first antenna structure 1a, the second antenna structure 1b, the third antenna structure 1c, and the conductive structure 1d are all electrically connected to the same conductive plate 2, as shown in FIG. 7, the second radiation part 1012a of the first antenna structure and the second radiation part 1012c of the third antenna structure may be obtained through processing by using a same etching or coating process, and the second radiation part 1012b of the second antenna structure and the second conductive part 1014 of the conductive structure id may be obtained through processing by using a same etching or coating process.

Similarly, the second short-circuit arm 103a of the first antenna structure and the second short-circuit arm 103c of the third antenna structure may also be obtained through processing by using a same process. As shown in FIG. 6, a through hole may be provided between the second radiation part 1012a of the first antenna structure and the second radiation part 1012c of the third antenna structure, and the second short-circuit arm 103a of the first antenna structure and the second short-circuit arm 103c of the third antenna structure may be conductive coatings coated on a hole wall of the through hole 6.

As shown in FIG. 7, the first radiation part 1011a of the first antenna structure and the first radiation part 1011c of the third antenna structure may also be conductive coatings disposed on corresponding side surfaces of the printed circuit board or structures obtained by etching the conductive layer. The first short-circuit arm 102a of the first antenna structure and the first short-circuit arm 102c of the third antenna structure may be obtained through processing by using a same etching or coating process with the conductive plate 2.

The second antenna structure 1b and the conductive structure id may be disposed with reference to the first antenna structure 1a and the third antenna structure 1c. Details are not described herein.

Still refer to FIG. 7. In the antenna 100b provided in this embodiment of this application, the first antenna structure 1a, the second antenna structure 1b, the third antenna structure 1c, the conductive structure 1d, and the conductive plate 2 may be of an integrally formed structure, and may be obtained through processing by using a same etching or coating process. In addition, the conductive plate 2 includes a reflective surface that is continuously disposed, and a projection of the first radiation part of each antenna structure on the first plate part 201 and a projection of the second radiation part of each antenna structure on the second plate part 202 each fall within a contour range of the reflective surface that is continuously disposed on the conductive plate 2, so that the conductive plate 2 can improve performance of directional radiation of a signal by the antenna 100b.

In the embodiments in FIG. 6 and FIG. 7, in the first antenna structure 1a and the third antenna structure 1c that are arranged in the second direction Y, a connection line may be disposed between the second radiation part 1012a of the first antenna structure and the second radiation part 1012c of the third antenna structure. In an embodiment, the second radiation part 1012a of the first antenna structure, the second radiation part 1012c of the third antenna structure, and the connection line therebetween may be integrally formed, or may be obtained through processing by using a same etching or coating process, to facilitate forming the second radiation part 1012a of the first antenna structure and the second radiation part 1012c of the third antenna structure that have a same length or width. In an embodiment, a width of a connection line between radiators of different antenna structures is less than or equal to ⅕ of a length of the radiation part.

In the embodiments in FIG. 6 and FIG. 7, the conductive structure id may also be referred to as a dummy antenna structure 1d, and a connection line may also be disposed between the dummy antenna structure id and the second antenna structure 1b. In an embodiment, no feed point is disposed on the dummy antenna structure 1d, and no insulation hole or insulation gap is provided on the second conductive part 1014. It should be understood that, in an embodiment, no feed point is disposed on the dummy antenna structure 1d, but an insulation hole or an insulation gap may be provided on the second conductive part 1014, to form a conductive through hole similar to that in the radiator of the antenna structure, thereby increasing symmetry.

In addition, it should be noted that, in the antenna 100b provided in this embodiment of this application, a feed line of each antenna structure is electrically connected to a feed source in a one-to-one correspondence, in other words, the antenna structures are electrically connected to different feed sources. However, frequencies of signals fed by the corresponding feed sources of the antenna structures are the same, so that the antenna structures can radiate intra-frequency signals, and the antenna can radiate signals in a specific operating frequency band.

A size and radiation performance of the antenna 100b shown in FIG. 6 are described by using an example in which an operating frequency band of the antenna 100b is 7.737 GHz to 8.237 GHZ (for example, Channel 9). A center frequency f0 of the operating frequency band is 8 GHz. FIG. 8 is a B-direction view of the antenna 100b shown in FIG. 6. In the antenna 100b, a center spacing between the second radiation part 1012a of the first antenna structure and the second radiation part 1012b of the second antenna structure may be 18.75 mm, namely, λ0/2. A center spacing between the second radiation part 1012a of the first antenna structure and the second radiation part 1012c of the third antenna structure may be 18.75 mm, namely, 0.21310λo. In this case, a width W of the antenna 100b in the second direction Y may be 8.5 mm, and a size of the antenna 100b in the second direction Y is small.

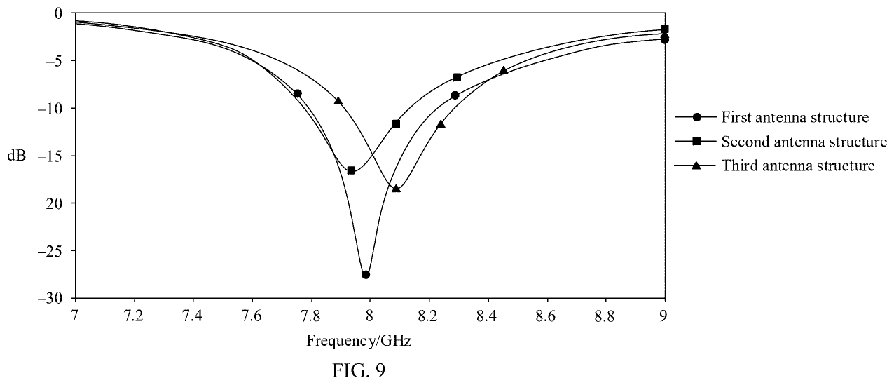

FIG. 9 shows S11 curves of the first antenna structure 1a, the second antenna structure 1b, and the third antenna structure 1c of the antenna 100b shown in FIG. 6. It can be learned from FIG. 9 that resonances generated by the three antenna structures are all used to cover 8 GHZ.

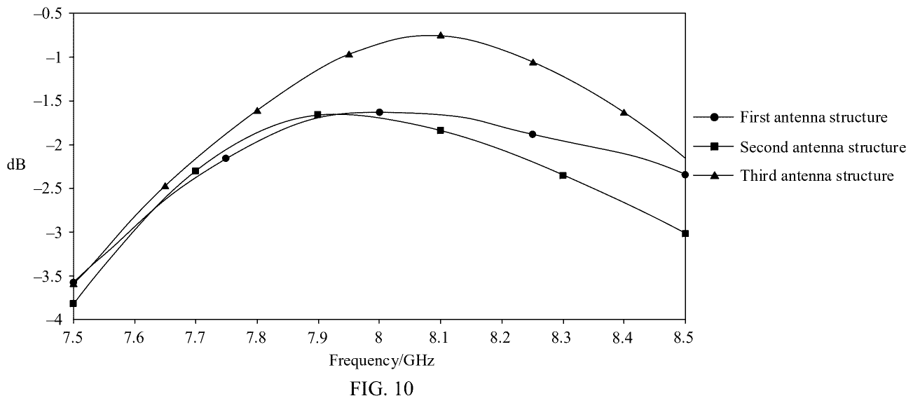

FIG. 10 shows average efficiency curves in operating frequency bands of the first antenna structure 1a, the second antenna structure 1b, and the third antenna structure 1c of the antenna 100b shown in FIG. 6. It can be learned from FIG. 10 that in-band average efficiency of each of the three antenna structures is greater than −2 dB. This may indicate that the antenna 100b provided in this embodiment of this application has high radiation efficiency.

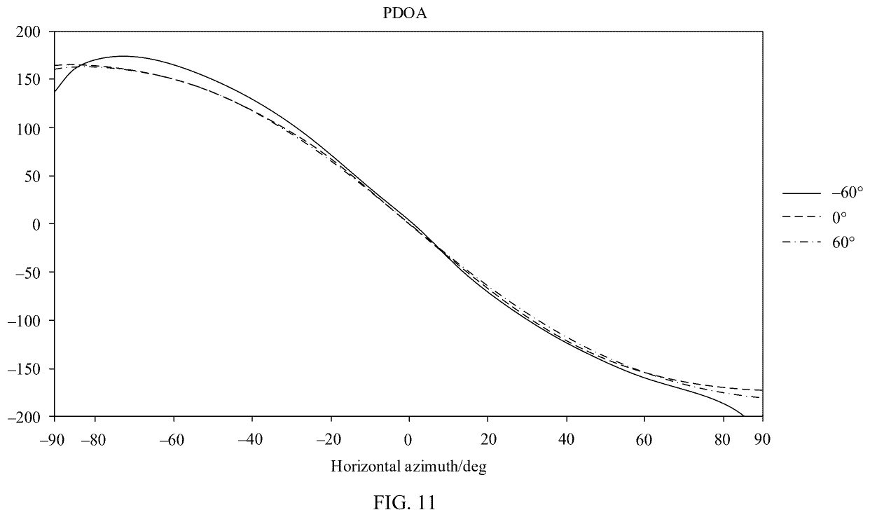

FIG. 11 shows a phase difference of arrival (PDOA) curve of the first antenna structure 1a and the second antenna structure 1b of the antenna shown in FIG. 6 at a horizontal azimuth, where a PDOA is a phase difference of a transmitted signal arriving at different receive ends, and may be used to reversely deduce a position of the transmitted signal. It can be learned from FIG. 11 that the PDOA curve of the first antenna structure 1a and the second antenna structure 1b at the horizontal azimuth has good monotonicity within an angle range of ±60°.

This indicates that accurate angle measurement and ranging can be performed in the horizontal direction through the first antenna structure 1a and the second antenna structure 1b.

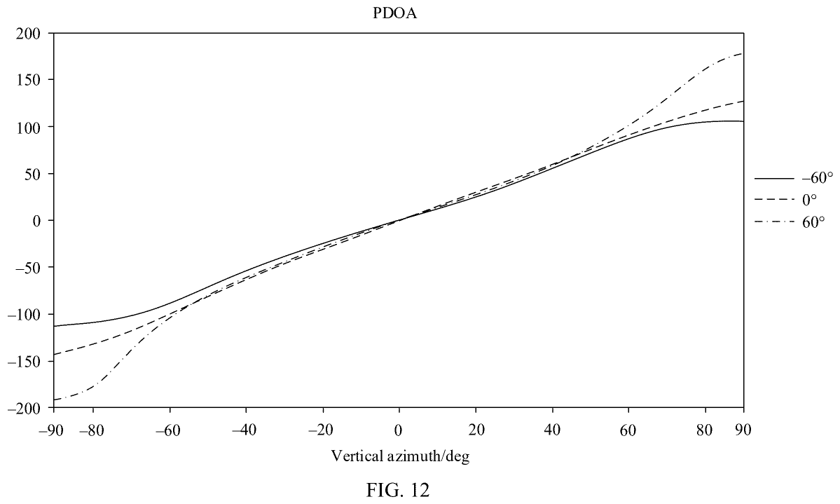

In addition, FIG. 12 shows a PDOA curve of the first antenna structure 1a and the third antenna structure 1c of the antenna 100b shown in FIG. 6 at a vertical azimuth. It can be learned from FIG. 12 that the PDOA curve of the first antenna structure 1a and the third antenna structure 1c at the vertical azimuth has good monotonicity within an angle range of ±60°. This indicates that accurate angle measurement and ranging can be performed in the vertical direction through the first antenna structure 1a and the third antenna structure 1c.

The following conclusion may be drawn from the foregoing analysis of the antenna 100b provided in FIG. 6: The antenna 100b provided in this application has a small size, and the antenna 100b can stably operate in an operating frequency band, and has high radiation efficiency. In addition, the antenna 100b has high angle measurement and ranging accuracy, so that an accurate positioning function can be implemented.

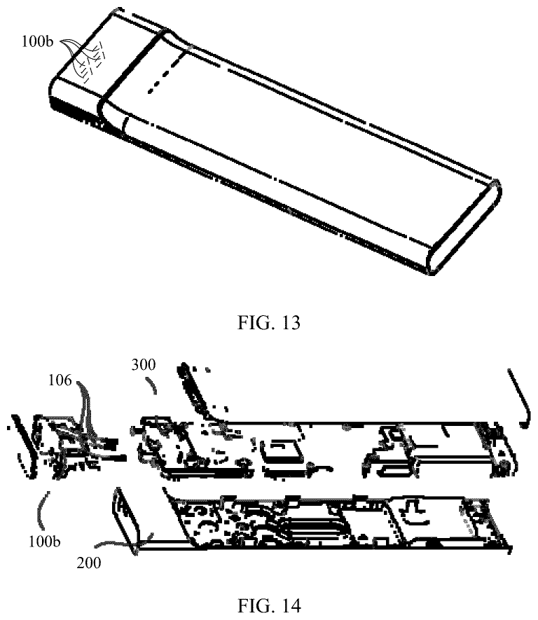

Based on the foregoing descriptions of the antenna 100b provided in this application, because a size of the antenna 100b is small, the antenna 100b may be disposed on a side surface of the housing of the electronic device. An example in which the electronic device is a remote control is still used. FIG. 13 is a diagram of a structure of a remote control according to an embodiment of this application. In a use process of the remote control, because of a particularity of a handheld posture of the remote control, a signal transceiver of the remote control is usually disposed on a top of a housing 200 of the remote control, so that a to-be-measured object can be controlled by pointing the top of the housing 200 of the remote control toward the to-be-measured object. Based on this, in the remote control shown in FIG. 13, an antenna 100b is disposed in the housing 200, and the antenna 100b may be disposed on a top side surface of the housing 200 of the remote control, where the top side surface is an inner side surface of the top of the housing 200. In addition, a second radiation part of each antenna structure of the antenna 100b may be attached to the top side surface of the housing 200 or may be spaced away from the top side surface of the housing 200. In this way, when the remote control is used for positioning, use of the remote control may be convenient, and user experience can be improved.

In addition, refer to FIG. 14. FIG. 14 is a diagram of an exploded structure of the remote control shown in FIG. 13. The remote control further includes a main board 300, and the main board 300 is provided with a processor (not shown in FIG. 14). Therefore, feed lines 106 of the antenna structures of the antenna 100b may be electrically connected to the processor, so that the processor feeds each antenna structure through the feed line 106, to implement a positioning function of the electronic device.

It should be noted that the electronic device provided in the embodiments of this application may be a remote control, or may be another handheld electronic device like a mobile phone or a car key. During use of such an electronic device, due to the particularity of the handheld posture, to ensure efficient reception and transmission of wireless signals, the antenna 100b may be disposed on a small-area side surface of the electronic device in a thickness direction, for example, disposed on a side surface at the top of the electronic device. In this way, while the to-be-measured object is accurately positioned by the electronic device, convenience of the electronic device can be improved.

It is clear that a person skilled in the art can make various modifications and variations to this application without departing from the protection scope of this application.

This application is intended to cover these modifications and variations of this application provided that they fall within the scope of protection defined by the following claims and their equivalent technologies.

1-20. (canceled)

21. An antenna comprising:
a conductive plate comprising a first plate part and a second plate part, wherein an edge of the first plate part is connected to an edge of the second plate part, there is a first included angle between the first plate part and the second plate part, and the first included angle is less than 180°; and
at least three antenna structures comprising a first antenna structure, a second antenna structure, and a third antenna structure, wherein:
each antenna structure of the at least three antenna structures comprises: a first radiation part and a second radiation part the first radiation part and the second radiation part are both located on a side that is of the conductive plate and that is away from the first included angle, the first radiation part comprises a first side edge and a third side edge that are disposed opposite to each other, the first side edge is electrically connected to the first plate part, and the third side edge is closer to the second radiation part than the first side edge, the second radiation part comprises a second side edge and a fourth side edge that are disposed opposite to each other, the second side edge is electrically connected to the second plate part, and the fourth side edge is closer to the first radiation part than the second side edge, and the third side edge and the fourth side edge are spaced away from each other,
the first antenna structure and the second antenna structure are arranged in a first direction, the first antenna structure and the third antenna structure are arranged in a second direction, and the first direction and the second direction are set at a specified included angle, and the second radiation parts of the at least three antenna structures are all located on a same side of the second plate part.

22. The antenna according to claim 21, wherein the second radiation parts of the at least three antenna structures are disposed on a same plane.

23. The antenna according to claim 21, wherein a plane on which the first radiation part is located is perpendicular to a plane on which the second radiation part is located.

24. The antenna according to claim 21, wherein a spacing di between the third side edge and the fourth side edge satisfies: 0.02λ≤d1≤0.04λ, and λ is a dielectric wavelength corresponding to a center frequency of an operating frequency band of the antenna.

25. The antenna according to claim 24, wherein a width d2 of the first radiation part from the first side edge to the third side edge and a width d3 of the second radiation part from the second side edge to the fourth side edge satisfy: d2/d3=0.8 to 1.2.

26. The antenna according to claim 25, wherein a length of the third side edge is less than or equal to d1+d2+d3, a length of the fourth side edge is less than or equal to d1+d2+d3, and λ0/4≤d1+d2+d3≤λ0/2, and λ0 is a wavelength corresponding to the center frequency of the operating frequency band of the antenna in free space.

27. The antenna according to claim 21, wherein:
each antenna structure further comprises a first short-circuit arm and a second short-circuit arm, the first radiation part and the first plate part are spaced away from each other, and the first side edge is electrically connected to the first plate part through the first short-circuit arm; and
the second radiation part and the second plate part are spaced away from each other, and the second side edge is electrically connected to the second plate part through the second short-circuit arm.

28. The antenna according to claim 27, wherein in an arrangement direction from the first radiation part to the first plate part, a width of the first short-circuit arm is less than or equal to a length of the third side edge.

29. The antenna according to claim 27, wherein in an arrangement direction from the second radiation part to the second plate part, a width of the second short-circuit arm is less than or equal to a length of the fourth side edge.

30. The antenna according to claim 21, wherein each antenna structure further comprises a feed line, the feed line of each antenna structure is electrically connected to one feed source in a one-to-one correspondence, a feed point is disposed on the second radiation part of each antenna structure, and the feed line is electrically connected to the corresponding feed point, and signals fed by the corresponding feed sources into the at least three antenna structures are configured to have a same frequency.

31. The antenna according to claim 30, wherein the feed point and the fourth side edge are spaced away from each other, and in an extension direction of the fourth side edge, a distance deviation between the feed point and a middle position between two end parts of the fourth side edge is ±1 mm.

32. The antenna according to claim 21, wherein:
the first direction is perpendicular to the second direction, the first antenna structure and the second antenna structure that are arranged in the first direction are symmetrically disposed relative to a first plane of symmetry, the first plane of symmetry passes through a center point of a spacing between the first antenna structure and the second antenna structure, and the first plane of symmetry is perpendicular to the first direction; and
the first antenna structure and the third antenna structure that are arranged in the second direction are symmetrically disposed relative to a second plane of symmetry, the second plane of symmetry passes through a center point of a spacing between the first antenna structure and the third antenna structure, and the second plane of symmetry is perpendicular to the second direction.

33. The antenna according to claim 32, wherein:
the antenna further comprises a conductive structure, the conductive structure comprises a first conductive part and a second conductive part, the first conductive part is electrically connected to the first plate part, the second conductive part is electrically connected to the second plate part, and the second conductive part and the second radiation part of each antenna structure are located on a same side of the second plate part; and
the first conductive part and the first radiation part of the second antenna structure are symmetrically disposed relative to the second plane of symmetry, the first conductive part and the first radiation part of the third antenna structure are symmetrically disposed relative to the first plane of symmetry, the second conductive part and the second radiation part of the second antenna structure are symmetrically disposed relative to the second plane of symmetry, and the second conductive part and the second radiation part of the third antenna structure are symmetrically disposed relative to the first plane of symmetry.

34. The antenna according to claim 33, wherein the second conductive part and the second radiation part of each antenna structure are disposed on a same plane.

35. The antenna according to claim 33, wherein a center spacing L2 between the first antenna structure and the third antenna structure that are arranged in the second direction satisfies: λ0/4≤L2≤λ0/2, and λ0 is a wavelength corresponding to the center frequency of an operating frequency band of the antenna in free space.

36. The antenna according to claim 21, wherein:
the first antenna structure and the second antenna structure that are arranged in the first direction are symmetrically disposed relative to a first plane of symmetry, the first plane of symmetry passes through a center point of a spacing between the first antenna structure and the second antenna structure, and the first plane of symmetry is perpendicular to the first direction; and
the first antenna structure, the second antenna structure, and the third antenna structure are arranged in an isosceles triangle.

37. The antenna according to claim 21, wherein:
a center spacing L1 between the first antenna structure and the second antenna structure that are arranged in the first direction satisfies: λ0/4≤L1≤λ0/2, and λ0 is a wavelength corresponding to the center frequency of an operating frequency band of the antenna in free space; or
a center spacing L2 between the first antenna structure and the third antenna structure that are arranged in the second direction satisfies: λ0/4≤L2≤λ0/2, and λ0 is the wavelength corresponding to the center frequency of the operating frequency band of the antenna in free space.

38. The antenna according to claim 21, wherein the first plate part and the second plate part are perpendicularly disposed.

39. An electronic device comprising a housing and an antenna disposed in the housing, the antenna comprising:
a conductive plate comprising a first plate part and a second plate part, wherein an edge of the first plate part is connected to an edge of the second plate part, there is a first included angle between the first plate part and the second plate part, and the first included angle is less than 180°; and
at least three antenna structures comprising a first antenna structure, a second antenna structure, and a third antenna structure, wherein:
each antenna structure of the at least three antenna structures comprises: a first radiation part and a second radiation part, the first radiation part and the second radiation part are both located on a side that is of the conductive plate and that is away from the first included angle, the first radiation part comprises a first side edge and a third side edge that are disposed opposite to each other, the first side edge is electrically connected to the first plate part, and the third side edge is closer to the second radiation part than the first side edge, the second radiation part comprises a second side edge and a fourth side edge that are disposed opposite to each other, the second side edge is electrically connected to the second plate part, and the fourth side edge is closer to the first radiation part than the second side edge, and the third side edge and the fourth side edge are spaced away from each other,
the first antenna structure and the second antenna structure are arranged in a first direction, the first antenna structure and the third antenna structure are arranged in a second direction, and the first direction and the second direction are set at a specified included angle, and
the second radiation parts of the at least three antenna structures are all located on a same side of the second plate part.

40. The electronic device according to claim 39, wherein the second radiation part of each antenna structure is attached to a top side surface of the housing or is spaced away from a top side surface of the housing.
